(19) United States
(12) Patent Application Publication
(10) Pub. No.: US 2011/0122495 A1
(43) Pub. Date: May 26, 2011

(54) IMAGING LENS UNIT AND IMAGING APPARATUS

(75) Inventor: Mitsuhiro Togashi, Kanagawa (JP)

(73) Assignee: SAMSUNG YOKOHAMA RESEARCH INSTITUTE CO., LTD., Kanagawa (JP)

(21) Appl. No.: 12/439,663

(22) PCT Filed: Aug. 28, 2007
(86) PCT No.: PCT/JP2007/066640

§ 371 Date: Sep. 17, 2009

(30) Foreign Application Priority Data
Aug. 29, 2006 (JP) JP2006-232208

(51) Int. Cl. G02B 27/64; G02B 7/02

(52) U.S. Cl. 359/557

(57) ABSTRACT

An imaging lens that focuses light from a subject on an imaging surface, a lens holder that holds the imaging lens, a holder that holds the lens holder so as to be capable of moving along the optical axis of the imaging lens and capable of rotating in a tilting direction with respect to the optical axis, magnets and coils that independently cause drive forces to act in the direction along the optical axis with respect to the lens holder at at least three locations of the periphery of the lens holder, a Hall element that detects the attitude of the lens holder with respect to the optical axis, and a control apparatus that controls the magnitude and direction of the drive force of each coil in accordance with the detection output of the Hall element. In accordance with the present invention, in the cladding lens unit, it is possible to perform a movement in an optical axis direction of the imaging lens and a tilt movement with respect to the optical axis with a simple constitution.

### CROSS REFERENCE TO RELATED APPLICATIONS

This is a U.S. national stage of application No. PCT/JP2007/066640 filed on Aug. 28, 2007. Priority under 35 U.S.C. §119(a) and 35 U.S.C. §365(b) is claimed from Japanese Application No. 2006-232208, filed Aug. 29, 2006, the disclosure of which is also incorporated herein by reference.

### TECHNICAL FIELD

The present invention relates to an imaging lens unit that performs position correction of the position of an imaging lens in an optical axis direction and an angular position with respect to the optical axis, and an imaging apparatus.

Priority is claimed on Japanese Patent Application No. 2006-232208, filed Aug. 29, 2006, the content of which is incorporated herein by reference.

### BACKGROUND ART

In an imaging apparatus, such as a camera, there is conventionally known an imaging lens unit equipped with a camera shake correction function that corrects image blur by moving the imaging lens in a direction perpendicular to the optical axis and tilting it with respect to the optical axis upon detecting with a sensor that camera shake has occurred.

For example, Patent Document 1 discloses a camera shake correcting mechanism that supports an entire lens barrel including an imaging element with an elastic member, and performs camera shake correction by performing a tilting movement in two axial directions with respect to the optical axis.

Also, Patent Document 2 discloses a camera shake correcting mechanism that supports an entire lens barrel including an imaging element so as to be rotatable manner in two axial directions, and by applying a shaking force from the outside, performs camera shake correction with a tilting movement.

On the other hand, an imaging apparatus is generally provided with a mechanism that moves the imaging lens in the optical axis direction with respect to the imaging element in order to perform zoom operation and focus operation, separately from the camera shake correcting mechanism. As an example of this kind of moving mechanism in the optical axis direction, for example, Patent Document 3 discloses a lens driving apparatus that supports a lens so as to move in the optical axis direction with a blade spring and performs the focus operation by moving the lens support frame in the optical axis direction with a linear motor.

Also, Patent Document 4 discloses an imaging apparatus that moves a zoom lens group for performing a zoom operation in the optical axis direction and performs camera shake correction with a liquid crystal lens that varies the image focus location by changing the refractive-index distribution within a plane that intersects the optical axis.

Patent Document 1: Japanese Unexamined Patent Application, First Publication No. 2006-53358 (FIG. 1)

Patent Document 2: Japanese Unexamined Patent Application, First Publication No. 2006-23477 (FIG. 1)

Patent Document 3: Japanese Unexamined Patent Application, First Publication No. 2002-365514 (FIGS. 1 to 4)

Patent Document 4: Japanese Unexamined Patent Application, First Publication No. 2005-345520 (FIG. 1)

### DISCLOSURE OF THE INVENTION

### Problem to be Solved by the Invention

However, the conventional imaging lens units and imaging apparatuses described above have the following problems.

In the art disclosed in Patent Documents 1 and 2, although compact as a camera shake correcting mechanism, since it is necessary to provide a separate moving mechanism in the case of moving the imaging lens in the optical axis direction, the problem arises of the apparatus constitution becoming complicated.

Also, in the art disclosed in Patent Document 3, in order to perform camera shake correction, it is necessary to tilt the entire optical axis direction moving mechanism or move it in a direction perpendicular to the optical axis, which leads to an increase in size of the camera shake correcting mechanism and poor response.

Also, in the art disclosed in Patent Document 4, although it is capable of simplifying the camera shake correcting mechanism by using a liquid crystal lens, since the moving mechanism in the optical axis direction and the camera shake correcting mechanism are separately provided, it is necessary to separately provide an apparatus constitution and a control mechanism, leading to the problem of the apparatus constitution becoming complicated.

The present invention was achieved in view of the above circumstances, and has as its object to provide an imaging lens unit that fixes an imaging element and is capable of performing movement in the optical axis direction and tilting movement with respect to the optical axis of only the imaging lens with a simple constitution.

### Means for Solving the Problem

In order to solve the above issues, the imaging lens unit of the present invention has a constitution provided with an imaging lens that focuses light from a subject on an imaging surface; an optical holder that holds the imaging lens; an optical holder holding portion that holds the optical holder so as to be capable of moving along the optical axis of the imaging lens and capable of rotating in a tilting direction with respect to the optical axis; holder driving mechanisms that independently generate a drive force in the direction along the optical axis with respect to the optical holder at least three locations of the periphery of the optical holder; an attitude detecting sensor that detects the attitude of the optical holder with respect to the optical axis; and a holder drive control apparatus that controls the magnitude and direction of the drive force of each holder drive mechanism in accordance with the detection output of the attitude detecting sensor.

According to this invention, in accordance with the detection output of the attitude detecting sensor, it is possible to independently control the drive forces that act on at least three locations of the optical holder by the holder drive control apparatus, and it is possible to move the optical holder in the optical axis direction and possible to rotate the optical holder in a tilting direction with respect to the optical axis as required. For that reason, it is possible to perform separate or simultaneous movement in the direction along the optical axis of the imaging lens that is held in the optical holder and tilting movement of the lens optical axis with respect to the optical axis.

### EFFECT OF THE INVENTION

Since the imaging lens unit and imaging apparatus of the present invention are capable of independently controlling the drive forces that act on at least three locations of the periphery of an optical holder, they exhibit the effect of being able to perform movement in a direction along the optical axis of the imaging lens and tilting movement with respect to the optical axis with a simple constitution that has the same mechanism.

### BRIEF DESCRIPTION OF THE DRAWINGS

FIG. 1 is a perspective view that shows the outline constitution of an imaging lens unit according to the first embodiment of the present invention.

FIG. 2 is an exploded perspective view of the imaging lens unit according to the first embodiment of the present invention.

FIG. 3 is a plan view of the imaging lens unit according to the first embodiment of the present invention.

FIG. 4 is a cross-sectional view along lines A-B-C in FIG. 3.

FIG. 5 is a functional block drawing of the holder drive control apparatus of the imaging lens unit according to the first embodiment of the present invention.

FIG. 6A is a schematic operation principle drawing of the imaging lens unit according to the first embodiment of the present invention.

FIG. 6B is a schematic operation principle drawing of the imaging lens unit according to the first embodiment of the present invention.

FIG. 7 is a perspective view showing the outline constitution of the imaging lens unit according to the second embodiment of the present invention.

FIG. 8 is a plan view of the imaging lens unit according to the second embodiment of the present invention.

FIG. 9 is a cross-sectional view of the main portions along line D-D in FIG. 8.

FIG. 10 is a perspective view that shows the outside view of an imaging apparatus according to the third embodiment of the present invention.

### BRIEF DESCRIPTION OF THE REFERENCE NUMERALS

1 imaging element; 2 holder (optical holder holding portion); 3, 10 lens holder (optical holder); 3c spherical portion (spherical portion); 7 Hall element (attitude detecting sensor); 9 iron plate (magnetic body); 11 elastic holding member (elastic member); 20 control apparatus (holder drive control apparatus); 100, 110, 202 imaging unit (imaging lens unit); 200 digital camera (imaging apparatus)

### BEST MODE FOR CARRYING OUT THE INVENTION

Hereinbelow the embodiments of the present invention shall be described with reference to the appended drawings. Even in the case of the embodiments differing, the same reference numerals shall be given to the same or similar members, and common descriptions shall be omitted.

### First Embodiment

The imaging lens unit according to the first embodiment of the present invention shall be described.

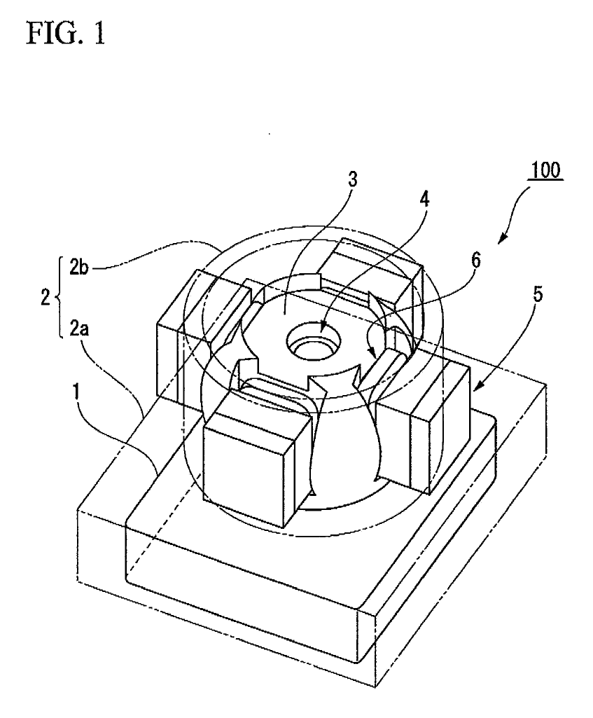

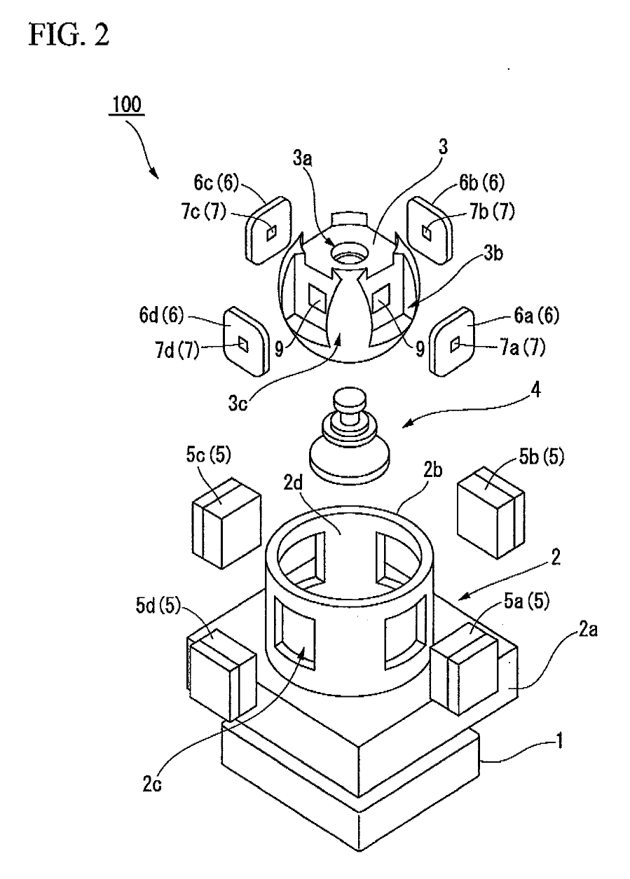

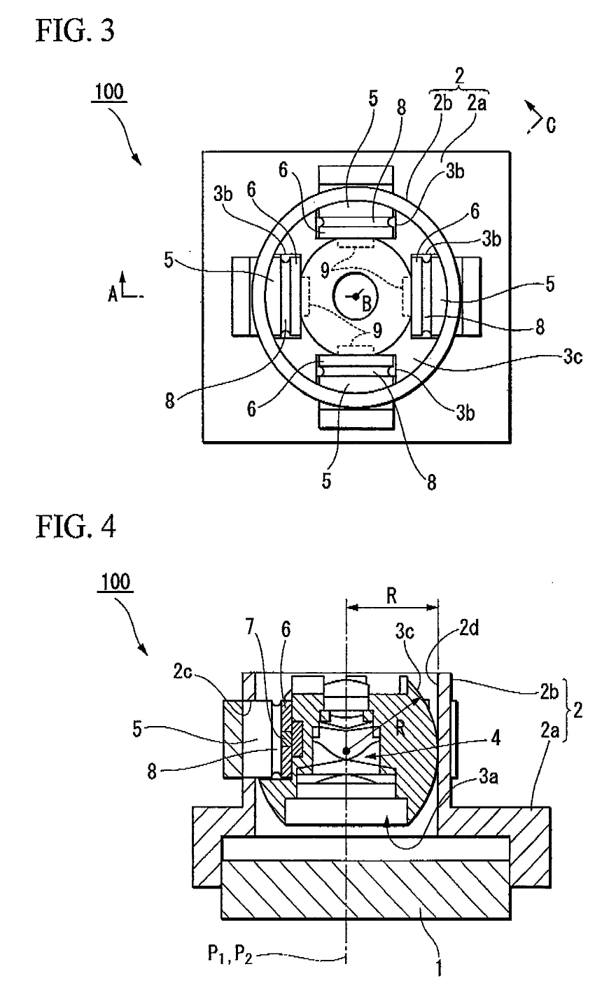

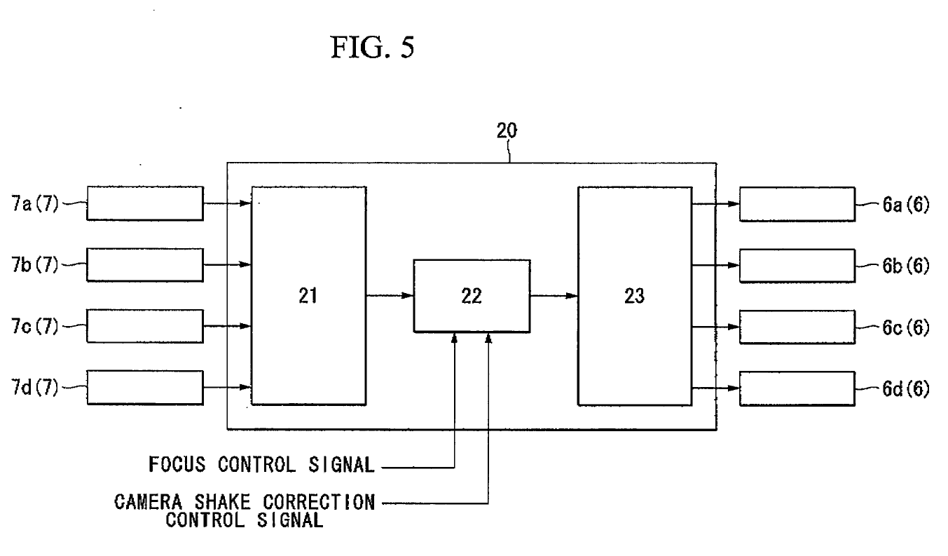

FIG. 1 is a perspective view that shows the outline constitution of an imaging lens unit according to the first embodiment of the present invention. FIG. 2 is an exploded perspective view of the imaging lens unit according to the first embodiment of the present invention. FIG. 3 is a plan view of the imaging lens unit according to the first embodiment of the present invention. FIG. 4 is a cross-sectional view along lines A-B-C in FIG. 3. FIG. 5 is a functional block drawing of the holder drive control apparatus of the imaging lens unit according to the first embodiment of the present invention.

An imaging unit 100 of the present embodiment is a unit made to be capable of performing an autofocus operation or a camera shake correction operation and the like by moving the imaging lens in a direction along the optical axis with respect to an imaging element and tilting the lens optical axis with respect to the optical axis. The imaging unit 100 is suitable as a portion of an imaging camera or an imaging portion that is built into an apparatus such as a mobile phone, PDA (Personal Digital Assistant), notebook computer, or computer monitor and the like.

The outline constitution of the imaging unit 100, as shown in FIGS. 1 to 5, has an imaging element 1, a holder 2, a lens holder 3, an imaging lens 4, and a control apparatus 20.

The imaging element 1 images light from the imaging lens 4, and has a plurality of light-receiving sensors arranged in a lattice pattern in an imaging area having an approximately rectangular shape in plan view. For example, it is possible to adopt a CCD or CMOS sensor or the like.

The holder 2 has an imaging element holding portion 2a that holds the imaging element 1 in a fixed position and a sleeve portion 2b that has a cylindrical inner surface with a radius R centered on the optical axis P₁ that is a reference axis of imaging (refer to FIG. 4). The sleeve portion 2b is provided facing the imaging area of the imaging element 1 which the imaging element holding portion 2a holds.

Here, the optical axis P₁ used as the reference axis of imaging passes through the center position of the imaging area, within the normal of the imaging area of the imaging element 1 held in the holder 2.

In the side of the holder 2, as shown in FIG. 2, four magnet holding holes 2c that has square holes that have their centers on two axes that intersect the optical axis P₁ and mutually intersect, and a magnet 5 is fitted in each magnet holding hole 2c so that the magnetic pole is aligned in the direction along the optical axis P₁ on the interior side of the sleeve portion 2b.

In order to hold the lens holder 3 in a slidable manner by the cylindrical inner surface of the holder 2, as shown in FIG. 4, shapes such as a lens mirror frame portion 3a and a coil holding slot 3b are formed in a sphere of radius R in which the vertical direction is cut off in the drawing, and a spherical portion 3c that has a radius R remains on the side surface of the direction intersecting the center axis that extends in the vertical direction of the drawing.

Here, the radius R of the sleeve portion 2b and the spherical portion 3c is set so that the spherical portion 3c fits so as to make freely slidable contact with the sleeve portion 2b in the range of the drive forces described below that are applied to the lens holder 3.

The lens holder 3 is made of a nonmagnetic material such as a synthetic resin.

The lens mirror frame portion 3a is a hole portion that is bored through along the center axis of the lens holder 3 in order to position and hold the imaging lens 4. For this reason, the center axis of the lens holder 3 agrees with the lens optical axis P₂ of the imaging lens 4.

The coil holding slot 3b serves to fix and hold a coil 6 in the periphery of the lens holder 3 in a state of facing the magnet 5 that is held in the magnet holding hole 2c of the holder 2. As for the method of fixing the coil 6, it is possible to employ a method such as adhesion.

In the present embodiment, when the lens holder 3 is disposed in the sleeve portion 2b, it is provided in a square slot shape (refer to FIG. 2) opening upward when viewed from the side in the four directions approximately facing the respective magnet holding holes 2c.

Each of the coils 6 provided in the coil holding slots 3b in the present embodiment intersects the lens optical axis P₂ and is arranged so that the direction facing the magnet holding hole 2c becomes the center axis of the winding, and the respective lead wire (not illustrated) is connected to a coil current control portion 24 of a control apparatus 20, with current being independently supplied thereto (refer to FIG. 5).

Then, as shown in FIGS. 3 and 4, a magnetic fluid 8 is injected in a gap between the coil 6, which is fixed in the coil holding slot 3b, and the magnet 5 that faces the coil 6, with the magnetic fluid 8 imparting viscous damping to relative movement of the magnet 5 and the coil 6.

The magnetic fluid 8 is mainly held in the gap between the magnet 5 and the coil 6 by the magnetic force of the magnet 5.

Moreover, a Hall element 7 is provided in the center portion of each coil 6 and, by detecting the magnitude of flux density, detects the position with respect to the facing magnet 5.

In the present embodiment, as shown in FIG. 2, when the magnets 5 are arranged as magnets 5a, 5b, 5c, 5d in a counterclockwise manner viewed from above and the coils 6 facing them respectively are arranged as coils 6a, 6b, 6c, 6d, the Hall elements 7a, 7b, 7c, 7d are respectively provided corresponding to the subscripts.

The detection output of each Hall element 7 is led to a position attitude detecting portion 21 in the control apparatus 20 with a lead wire (not illustrated).

Also, an iron plate 9 that causes the lens holder 3 to float by causing the magnetic force of the magnet 5 to act is respectively provided between the coil 6, Hall element 7 and the lens holder 3. Note that the iron plate 9 is only one example, and for example it may be a magnetic body that is constituted by hardening a magnetic powder or dispersing it in a synthetic resin.

The imaging lens 4, which serves to focus the image of a subject on the imaging area of the imaging element 1, consists of a suitable lens or lens group that is arranged on the lens optical axis P₂. As a constituent element other than a lens, it is possible to provide an optical element that does not have power, such as a filter or aperture.

With the above constitution, in the assembled state of the imaging unit 100, the attractive forces of the magnets 5 on the iron plates 9 are balanced, and the center of each coil 6 is at rest at a reference position facing the center of each magnet 5. At this time, the lens optical axis P₂ is in agreement with the optical axis P₁ (refer to FIG. 4).

When current is supplied to each coil 6, an electromagnetic force acts on each magnet 5 by the magnetic field generated according to the current value, each coil 6 receives attraction or repulsion as a reaction, and the drive forces in the direction of the optical axis P₁ come to be biased to the lens holder 3.

The control apparatus 20 controls the balance of the drive forces biased by the lens holder 3 to realize movement in a direction along the optical axis P₁ of the lens holder 3 and rotating movement that tilts with respect to the optical axis P₁.

The functional block constitution of the control apparatus 20 has the position attitude detecting portion 21, an operation processing portion 22, and a coil current control portion 23, as shown in FIG. 5.

They may be constituted from dedicated hardware respectively corresponding to the block function, or may be realized by a computer provided with a CPU, memory and suitable input/output interface or the like.

Moreover, a specific apparatus composition of the control apparatus 20 may be one also used as another control apparatus external to the imaging unit 100.

The position attitude detecting portion 21 detects the current position with respect to each magnet 5 that each Hall element 7 faces based on change of the magnitude of the flux density which each Hall element 7 detects, and sends the detection output to the operation processing portion 22.

Since the magnetic pole of the magnet 5 is aligned in the direction along the optical axis P₁, when the Hall element 7 moves in tandem with movement of the lens holder 3, the flux density increases the closer the Hall element 7 comes to one magnetic pole. For that reason, by correcting the relationship between the amount of movement of a lens holder 3 and change of flux density beforehand and storing it as a conversion formula or table and the like, it is possible to detect the amount of movement along the optical axis P₁ at a position of each Hall element 7.

The operation processing portion 22 calculates the position of the lens holder 3 in the direction along the optical axis P₁ and the tilt of the lens optical axis P₂ with respect to the optical axis P₁ from the current position of each Hall element 7 sent from the position attitude detecting portion 21. The operation processing portion 22 calculates the discrepancy from the control target position of the lens holder 3 referring to a focus control signal and a camera shake correction control signal which are supplied from outside of the imaging unit 100. The operation processing portion 22 calculates the coil current that adjusts each drive force, corresponding to the discrepancy from the target position, and sends it to the coil current control portion 23.

Here, the focus control signal is a control signal that detects the amount of defocus with a suitable focus detecting device and converts it to a movement target amount in the direction along the optical axis P₁ of the imaging lens 4.

The camera shake correction control signal is a control signal that detects the amount of camera shake by a suitable camera shake detecting apparatus such as an acceleration sensor or image processing and, in order to suppress the image blur to a permissible value or below, converts it to a target value of tilt movement of the lens optical axis P₂ to be tilted with respect to the optical axis P₁.

The coil current control portion 23 is for sending electricity to the coils 6a, 6b, 6c, and 6d according to each coil current value sent from the operation processing portion 22.

Next, the operation of the imaging unit 100 shall be described.

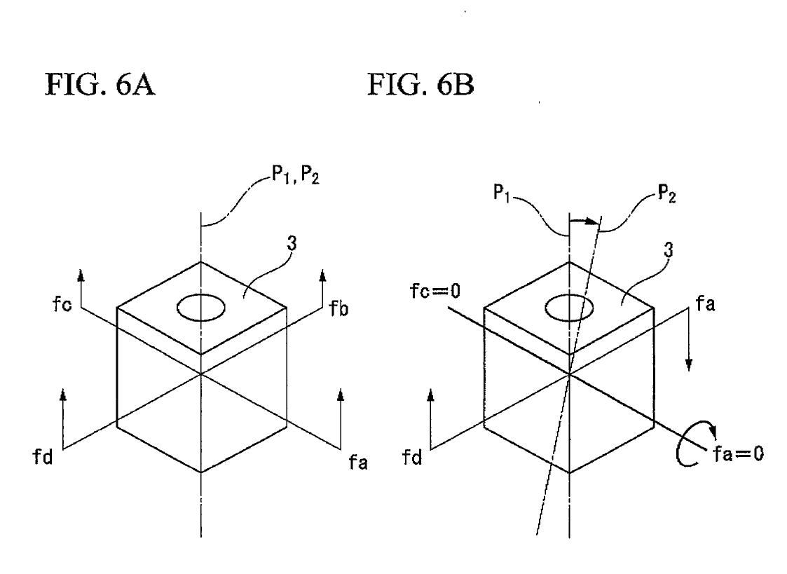

FIG. 6A and FIG. 6B are schematic operation principle drawings of the imaging lens unit according to the first embodiment of the present invention.

In the imaging unit 100, the output from each Hall element 7 is sent to the position attitude detecting portion 21, whereby the position of each Hall element 7 with respect to each magnet 5 that is fixed in the holder 2 is detected, and is sent to the operation processing portion 22. Then, in the operation processing portion 22, the position information on the optical axis P₁ of the center position of the lens holder 3 and the attitude information of the lens optical axis P₂ with respect to optical axis P₁ are always computed.

And from outside of the apparatus, the focus control signal and the camera shake correction control signal are input to the control apparatus 20.

In the operation processing portion 22, the discrepancy (deviation) of the current position and attitude of the lens holder 3 with respect to the movement target value are computed based on the focus control signal and the camera shake correction control signal. In accordance with the respective discrepancy (deviation), the drive forces to act on the lens holder 3 are computed.

For example, in the case of there being only a discrepancy in the position in direction along the optical axis P₁ (that is, the attitude deviation is 0), as shown in FIG. 6A, for an electromagnetic force fₐ from the magnet 5a which acts on the coil 6a, and similarly the other electromagnetic forces f_{b}, f_{c}, f_{d} corresponding to the subscripts of the coils 6, a control signal that adjusts the balance so that the directions and magnitudes thereof become identical is sent to the coil current control portion 23, and the coil current is sent to the coils 6a, 6b, 6c, and 6d.

Thereby, since a translational force along the optical axis P₁ acts on the lens holder 3, the lens holder 3 moves in parallel with the spherical portion 3c following along the inner surface of the sleeve portion 2b.

When the present position of the lens holder 3 reaches the target position, since the deviation with respect to the focus control signal becomes 0, the movement is stopped.

Moreover, for example due to the camera shake correction, in the case of only tilting the lens optical axis P₂ with respect to the optical axis P₁ (in the case of the position deviation being 0), for example as shown in FIG. 6B, in the case of it being necessary to rotate around an axis line that connects the magnets 5a, 5c in a clockwise manner when viewed from the side of the magnet 5a, coil currents are flowed so as to constitute a force couple in which fₐ=f_{c}=0, and f_{b} faces down in the drawing and f_{d} faces up in the drawing in a manner becoming the same electromagnetic force.

Thereby, the lens holder 3 rotates about the center of the spherical portion 3c by sliding on the inner surface of the sleeve portion 2b along the surface of the spherical portion 3c. When the present position of the lens holder 3 reaches the target position, since the deviation with the focus control signal becomes 0, movement is stopped.

Here, since each magnetic fluid 8 that is interposed in a gap between the magnet 5 and the coil 6 dissipates energy by moving in the space between the magnet 5 and the coil 6 in accordance with the relative displacement between the magnet 5 and the coil 6, it imparts viscous damping to movement of the lens holder 3. For that reason, by suitably adjusting the injection rate and viscosity of the magnetic fluid 8, it is possible to adjust the viscous damping and ensure the stability of position control.

In a general case in which both the position deviation and attitude deviations are not 0, according to the state of overlapping the deviations, by setting the direction and magnitude of the electromagnetic forces fₐ, f_{b}, f_{c}, f_{d}, it is possible to perform movement that simultaneously cancels the respective deviations.

That is, by the imaging unit 100, it is possible to simultaneously realize movement in a direction along the optical axis and rotation that tilts with respect to the optical axis with the same mechanism and the same control system. For that reason, it is possible to achieve a simple and compact constitution compared to performing the respective movement control and rotational control with separate mechanisms and control systems.

### Second Embodiment

The imaging lens unit according to the second embodiment of the present invention shall be described.

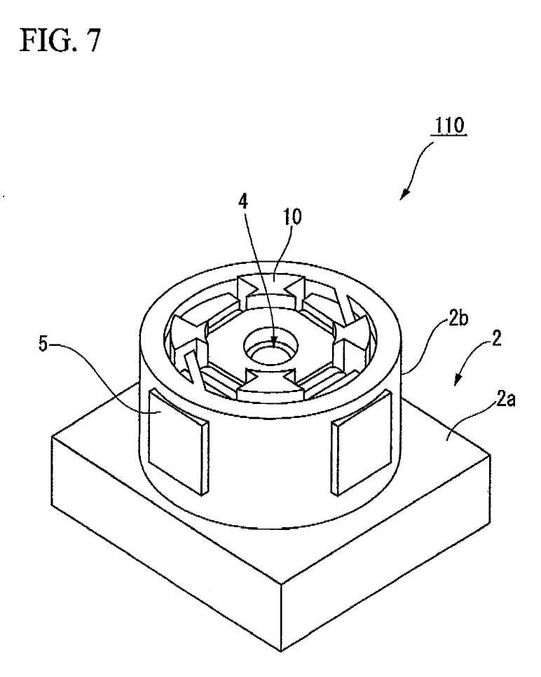

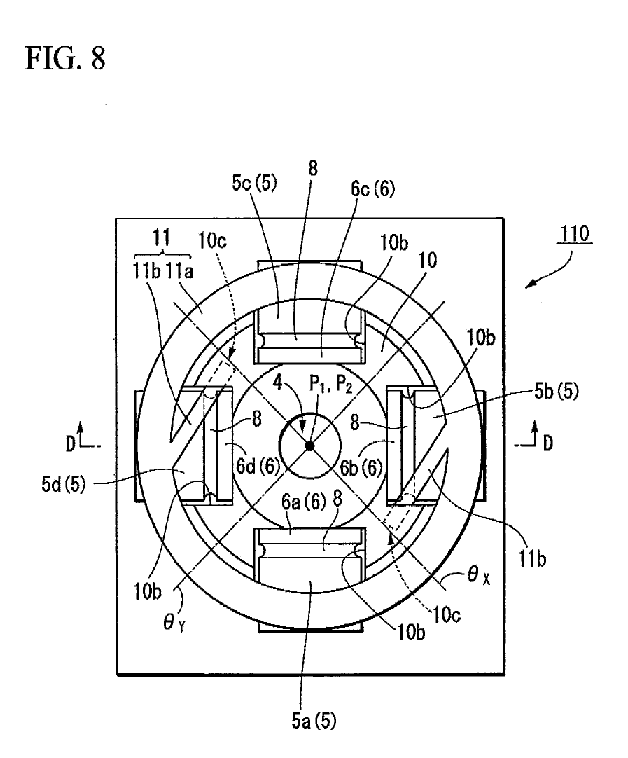

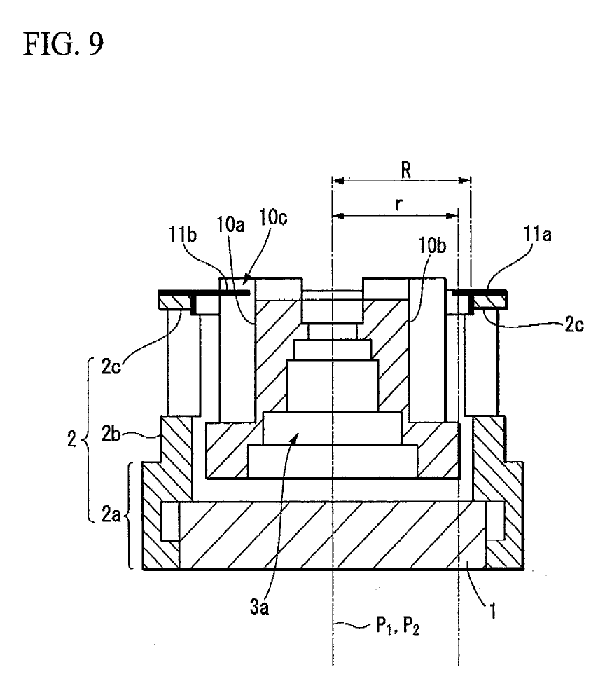

FIG. 7 is a perspective view showing the outline composition of the imaging lens unit according to the second embodiment of the present invention. FIG. 8 is a plan view of the imaging lens unit according to the second embodiment of the present invention. FIG. 9 is a cross-sectional view of the main portions along line D-D in FIG. 8.

As shown in FIGS. 7 and 8, an imaging unit 110 of the present embodiment has a lens holder 10 in place of the lens holder 3 of the imaging unit 100 of the first embodiment, and adds an elastic holding member 11. Hereinbelow, the description shall be given centered on the points of difference with the foregoing embodiment.

FIG. 9 shows the main portions of the imaging unit 110, showing the holder 2, the lens holder 10, and the elastic holding member 11.

The lens holder 10, as shown in FIGS. 8 and 9, is of a cylindrical member which has a radius r that is small compared with the inner radius R of the sleeve portion 2b, with the lens mirror frame portion 3a formed in the center portion, and a coil holding slot 10b having the same shape as the coil holding slot 3b formed in the side surface portion.

The elastic holding member 11, as shown in FIG. 8, is blade spring portions 11b, 11b that, in addition to being extended in the horizontal direction (paper surface direction in FIG. 8) in the approximate circumferential direction of an attachment portion 11a at the inner side in the radial direction of the circular attachment portion 11a that is fixed to the upper end surface of the sleeve portion 2b, are provided with axial symmetry with respect to the center axis of the attachment portion 11a that is approximately in agreement with the optical axis P₁.

The distal end portion of each blade spring portion 11b in the extended direction is fixed in a blade spring holding portion 10c that is provided between the coil holding slots 10b and 10b at the upper end portion (upward direction in FIG. 9) of the lens holder 10.

Since the blade spring portions 11b are extended along the approximate circumferential direction of the attachment portion 11a, the blade spring holding portions 10c can be provided in the vicinity of the attachment portion 11a. For that reason, the lens holder 10 is elastically supported in a direction along the optical axis P₁ at mutually symmetrical periphery positions with respect to the center axis by the two blade spring portions 11b at the upper end portion.

As the material of the blade spring portions 11b, it is possible to employ a metal thin plate or synthetic resin that provides the required elastic resilience.

Note that the blade spring portions 11b may be aligned in the circumferential direction by providing them in a circular shape along the inner diameter of the attachment portion 11a, but in the present embodiment the blade spring portions 11b are aligned in the approximate circumferential direction by extending the blade spring portions 11b in an approximate straight line in the vicinity of the attachment portion 11a.

Also, in the present embodiment, by providing the blade spring holding portions 10c between the coils 6a, 6b and between the coils 6c, 6d, respectively, the positional relation between each blade spring holding portion 10c and the coils 6 in a plan view is approximately symmetrical with respect to a straight line 0ₓ that connects the blade spring holding portions 10c, 10c and passes through the center axis of the lens holder 10 (refer to FIG. 8).

By doing so, in each blade spring holding portion 10c, it is possible to make the moment of the drive forces applied from the coils 6 during energization of the coils 6 approximately symmetrical with respect to the straight line 0ₓ. For that reason, the movement control of the lens holder 10 becomes simple, which is preferred.

According to the imaging unit 110, the lens holder 10 is movably held in the direction of the optical axis P₁ by the blade spring holding portions 10c at two locations at the upper end surface and shifted in the radial direction from the center axis. Accordingly, when drive forces act on the lens holder 10, the blade spring portions 11b deform, and it is possible for the lens holder 10 to move three-dimensionally in the range of the gap with the inner surface of the sleeve portion 2b.

For example, when the electromagnetic force that acts from each coil 6 at the time of coil energization is respectively set to fₐ, f_{b}, f_{c}, and f_{d} as in the first embodiment, it is possible to perform parallel movement along the optical axis P₁ by making each electromagnetic force have the same magnitude in the same direction. In this case, due to the deformation of the blade spring portions 11b, the lens holder 10 receives the tensile force in the circumferential direction from the blade spring holding portions 10c. But since each blade spring portion 11b is provided in axial symmetry with respect to the center axis of the lens holder 10, the tensile forces act as a force couple, and so the forces balance in the circumferential direction by minute rotation of the lens holder 10 about the center axis, and so it can smoothly move in the optical axis direction. That is, in a strict sense the lens holder 10 performs helical motion, but since it is helical motion about the optical axis P₂, it does not influence the image formation performance of the imaging lens 4, which is an axial symmetry optical system.

Moreover, by making fₐ, f_{d} and f_{b}, f_{c} have the same magnitude in opposite directions, it is possible to perform rotational movement about the straight line 0ₓ.

Also, by making fₐ, f_{b} and f_{c}, f_{d} have the same magnitude in opposite directions, it is possible to perform rotational movement about the straight line 0_{y} (refer to FIG. 8) that intersects the straight line 0ₓ and the optical axis P₁.

By adjusting the balance of the drive forces that used these electromagnetic forces with the control apparatus 20, it is possible to simultaneously realize overlapping of the above movements and movement that includes movement in the direction of the optical axis P₁ and rotation that tilts with respect to the optical axis P₁. For that reason, similarly to the first embodiment, it is possible to control the position of the imaging lens 4 and the attitude of the lens optical axis P₂, in accordance with the focus control signal and the camera shake correction control signal.

### Third Embodiment

The imaging apparatus according to the third embodiment of the present invention shall be described.

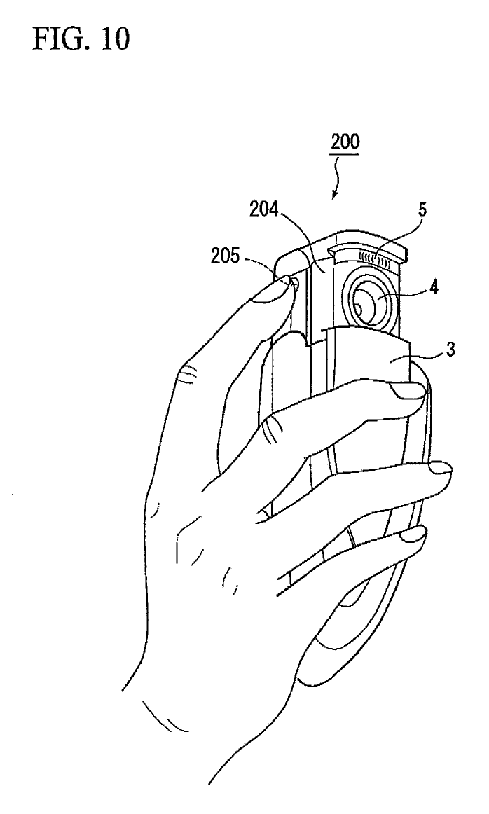

FIG. 10 is a perspective view that shows the outside view of the imaging apparatus according to the third embodiment of the present invention.

In a digital camera 200 of the present embodiment, as shown in FIG. 10, an optical unit 204 is provided in a freely slidable manner in a camera body 201.

An imaging unit 202 that images a subject, a strobe portion 203 that performs speed light photography, a shutter release 205, and the like are formed in the optical unit 204.

As for the imaging unit 202, it is possible to adopt all of the imaging lens units such as the imaging units 100, 110 of the first and second embodiments, respectively.

The camera shake detection sensor made of an acceleration sensor or the like and an autofocus mechanism (not illustrated) are built into the camera body 201, and a control portion that generates the camera shake correction control signal and the focus control signal by their detection output and sends it to the imaging unit 202 is provided.

According to the digital camera 200 of the present embodiment, since it is possible with the imaging unit 202 to perform movement of the imaging lens in the optical axis direction and tilt movement with respect to the optical axis with a simple constitution that has the same mechanism, it is possible to achieve an imaging apparatus that is compact and has high performance.

Note that the above description was given with the example of the case of the drive forces acting on the optical holder at four locations, but in order to cause the lens optical axis to tilt in a desired direction with respect to the optical axis, balance control may be performed by causing the drive forces to act at least three locations.

Also, in the above-described first embodiment, as the optical holder, the lens holder 3 was described with the example of the shape of the lens mirror frame portion 3a, the coil holding slot 3b and the like being formed in a sphere with the vertical direction being cut away. But provided a spherical portion is formed with a fixed diameter that has one center on the lens optical axis of the imaging lens that slidably inscribes at least three points in the cylindrical surface of the holder holding portion, the outer shape of the optical holder is not restricted to the shape of cutting away this kind of sphere.

Also, in the above-described second embodiment, as the optical holder, the lens holder 10 was described with the example of having an approximately cylindrical appearance, but provided it is possible to open a gap in which the required rotational movement is possible with the holder holding portion, the shape of the optical holder is not restricted to an approximately cylindrical appearance.

Also, in the above description, the example was described of interposing a magnetic fluid between the coil and magnet in order to impart damping, but in the case of sufficient damping being obtained without interposing a magnetic fluid, it is possible to omit the magnetic fluid.

Also, in the above description, the example was described of the case of using the Hall element that is a magnetic sensor as the attitude detecting sensor, but if it is possible to detect the relative movement of the optical holder with respect to the holder holding portion, another sensor may be employed. For example, an acceleration sensor, an optical sensor, an electrostatic capacity sensor, and the like may be used.

Also, in the second embodiment, the description was given with the example using a blade spring as the elastic member, but provided it is an elastic member that is capable of applying an elastic resilience to the optical holder, it is not restricted to a blade spring. For example, a bar-shaped elastic member that employs flexure, a bar-shaped elastic member that employs twisting such as a torsion bar, an elastic member that employs compression, pulling such as synthetic rubber or a coil spring and the like may be favorably employed.

Also, in the above description, the example was described of the case of the holder driving mechanism consisting of a magnet and coil, and directly causing electromagnetic force to act on the optical holder during coil energization. Since a force couple can be generated if it is possible to independently drive the optical holder at least three locations, besides a linear motor, it may be one that directly drives with a piezoelectric device or an artificial muscle, or one that indirectly drives via a well-known transmission mechanism such as a gear transmission mechanism, spring, lever, leverage and the like.

Also, in the third embodiment above, the description was given with the example of the case of the imaging apparatus being digital camera, but the imaging apparatus is not restricted to this. For example, the imaging apparatus may be an imaging apparatus that is built into an apparatus such as a mobile phone, PDA, notebook computer, or computer monitor and the like.

Also, the constituent elements that are disclosed in the above embodiments, if technically possible, can be implemented by suitably combining within the scope of the technical ideas of the present invention.

Here, regarding the correspondence relationship between the terms of the above-described embodiments and terms of the claims, the cases where the names differ shall be described.

The imaging units 100, 110, 202 are respectively one embodiment of the imaging lens unit. The holder 2 is one embodiment of the optical holder holding portion. The lens holders 3, 10 are one embodiment of the optical holder. The control apparatus 20 is one embodiment of the holder drive control apparatus. The spherical portion 3c is one embodiment of the spherical portion. The iron plate 9 is one embodiment of the magnetic body.

The elastic holding member 11 is one embodiment of the elastic member. The magnet 5 and the coil 6 constitute one embodiment of the holder driving mechanism. The Hall element 7 is one embodiment of the attitude detecting sensor. The digital camera 200 is one embodiment of the imaging apparatus.

### INDUSTRIAL APPLICABILITY

According to the present invention, it is possible to provide an imaging lens unit that is capable of achieving movement of only an imaging lens in an optical axis direction and the tilt movement of the imaging lens with respect to the optical axis with a simple constitution.

1. An imaging lens unit comprising:
an imaging lens that focuses light from a subject on an imaging surface;
an optical holder that holds the imaging lens;
an optical holder holding portion that holds the optical holder so as to be capable of moving along the optical axis of the imaging lens and capable of rotating in a tilting direction with respect to the optical axis;
holder driving mechanisms that independently generate a drive force in the direction along the optical axis with respect to the optical holder at least three locations of the periphery of the optical holder;
an attitude detecting sensor that detects the attitude of the optical holder with respect to the optical axis; and
a holder drive control apparatus that controls the magnitude and direction of the drive force of each holder drive mechanism in accordance with the detection output of the attitude detecting sensor.

2. The imaging lens unit according to claim 1, wherein each holder driving mechanism comprises:
a coil that is provided in the side surface of the optical holder; and
a magnet that is arranged in the periphery of the optical holder at a position approximately facing the coil and, during energization of the coil, causes the drive force to act in a direction along the optical axis with respect to the coil.

3. The imaging lens unit according to claim 2, wherein a magnetic fluid is interposed between the coil and the magnet.

4. The imaging lens unit according to claim 2, wherein the optical holder is provided with a magnetic body at a position facing the magnet.

5. The imaging lens unit according to claim 1, wherein the optical holder has a spherical portion with a fixed diameter that has one center on the lens optical axis of the imaging lens; and
the holder holding portion has a cylindrical surface that is extended in the direction along the optical axis that slidably inscribes at least three points of the spherical portion of the optical holder.

6. The imaging lens unit according to claim 1, wherein the optical holder is arranged in the inner side of the holder holding portion with a gap that allows movement in the optical axis direction and allows rotational movement with respect to the optical axis, and is fixed to the holder holding portion via an elastic member.

7. The imaging lens unit according to claim 6, wherein the elastic member is provided with a plurality of blade spring portions at the inner side of the holder holding portion that are extended in approximately the circumferential direction and have axial symmetry with respect to the optical axis.

8. An imaging apparatus provided with the imaging lens unit according to claim 1.

9. The imaging lens unit according to claim 3, wherein the optical holder is provided with a magnetic body at a position facing the magnet.

10. The imaging lens unit according to claim 2, wherein the optical holder has a spherical portion with a fixed diameter that has one center on the lens optical axis of the imaging lens; and
the holder holding portion has a cylindrical surface that is extended in the direction along the optical axis that slidably inscribes at least three points of the spherical portion of the optical holder.

11. The imaging lens unit according to claim 3, wherein the optical holder has a spherical portion with a fixed diameter that has one center on the lens optical axis of the imaging lens; and
the holder holding portion has a cylindrical surface that is extended in the direction along the optical axis that slidably inscribes at least three points of the spherical portion of the optical holder.

12. The imaging lens unit according to claim 4, wherein the optical holder has a spherical portion with a fixed diameter that has one center on the lens optical axis of the imaging lens; and
the holder holding portion has a cylindrical surface that is extended in the direction along the optical axis that slidably inscribes at least three points of the spherical portion of the optical holder.

13. The imaging lens unit according to claim 2, wherein the optical holder is arranged in the inner side of the holder holding portion with a gap that allows movement in the optical axis direction and allows rotational movement with respect to the optical axis, and is fixed to the holder holding portion via an elastic member.

14. The imaging lens unit according to claim 3, wherein the optical holder is arranged in the inner side of the holder holding portion with a gap that allows movement in the optical axis direction and allows rotational movement with respect to the optical axis, and is fixed to the holder holding portion via an elastic member.

15. The imaging lens unit according to claim 4, wherein the optical holder is arranged in the inner side of the holder holding portion with a gap that allows movement in the optical axis direction and allows rotational movement with respect to the optical axis, and is fixed to the holder holding portion via an elastic member.

16. An imaging apparatus provided with the imaging lens unit according to claim 2.

17. An imaging apparatus provided with the imaging lens unit according to claim 3.

18. An imaging apparatus provided with the imaging lens unit according to claim 4.

19. An imaging apparatus provided with the imaging lens unit according to claim 5.

20. An imaging apparatus provided with the imaging lens unit according to claim 6.

21. An imaging apparatus provided with the imaging lens unit according to claim 7.
